(19) United States
(12) Patent Application Publication
(10) Pub. No.: US 2025/0175799 A1
(43) Pub. Date: May 29, 2025

(54) SYSTEMS AND METHODS FOR EXTENDING VALIDATION DURATION

(71) Applicant: ZTE CORPORATION, Shenzhen (CN)

(72) Inventors: Junli LI, Shenzhen (CN); Nan ZHANG, Shenzhen (CN); Fangyu CUI, Shenzhen (CN); Yachao YIN, Shenzhen (CN)

(73) Assignee: ZTE CORPORATION, Shenzhen (CN)

(21) Appl. No.: 19/037,881

(22) Filed: Jan. 27, 2025

Related U.S. Application Data
(63) Continuation of application No. PCT/CN2022/131272, filed on Nov. 11, 2022.

(51) Int. Cl. H04W 12/104; H04W 12/61; H04W 64/00; H04W 72/231

(52) U.S. Cl. CPC H04W 12/104; H04W 12/61; H04W 64/00; H04W 72/231

(57) ABSTRACT

Presented are systems and methods for extending validation duration. A wireless communication device (e.g., UE) may receive at least one signaling from a wireless communication node (e.g., BS). The wireless communication device can determine whether to use an indicated duration of validity of positioning information of the wireless communication device, according to the at least one signaling.

### CROSS-REFERENCE TO RELATED APPLICATION

This application claims the benefit of priority under 35 U.S.C. § 120 as a continuation of PCT Patent Application No. PCT/CN2022/131272, filed on Nov. 11, 2022, the disclosure of which is incorporated herein by reference in its entirety.

### TECHNICAL FIELD

The disclosure relates generally to wireless communications, including but not limited to systems and methods for extending validation duration.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A wireless communication device (e.g., UE) may receive/obtain/acquire at least one signaling from a wireless communication node (e.g., base station (BS), gNB, and/or non-terrestrial device). The wireless communication device can determine whether to use an indicated duration of validity of positioning information of the wireless communication device, according to the at least one signaling.

In some implementations, the at least one signaling can include a system information block (SIB) signaling, a radio resource control (RRC) signaling, a media access control (MAC) signaling, and/or a downlink control information (DCI) signaling. In some implementations, the wireless communication device can determine, from the at least one signaling, at least one of: a first indication of the duration of validity, or a second indication to the wireless communication device on whether to use the first indication of the duration of validity.

In some implementations, the first indication can comprise: a value of the duration of validity, an index corresponding to the value of the duration of validity, or a coefficient value to be used with the duration of validity to determine the value of the duration of validity or a new duration of validity. The at least one signaling can consist of a single signaling. The wireless communication device can receive the single signaling from the wireless communication node. The single signaling can include (i) the first indication of the duration of validity, and/or (ii) the second indication on whether to use the first indication of the duration of validity. The wireless communication device can determine a value of the duration of validity in response to the second indication.

In some implementations, the wireless communication device can determine that the second indication is missing in the single signaling. The wireless communication device can determine, in response to the second indication being missing, to perform acquisition of positioning information. In some implementations, a value of the duration of validity can be a fixed value. In some implementations, a value of the duration of validity can be defined.

In some implementations, the wireless communication device can receive the second indication from the wireless communication node. The wireless communication device can determine a value of the duration of validity in response to the second indication In some implementations, the wireless communication device can receive a third indication to perform closed-loop correction from the wireless communication node. The wireless communication device can determine a value of the duration of validity in response to the third indication.

In some implementations, the wireless communication device can determine that the second indication is missing in the at least one signaling. The wireless communication device can determine, in response to the second indication being missing, to perform acquisition of positioning information or to perform the closed-loop correction and the acquisition of positioning information. In some implementations, the wireless communication device can receive, from the wireless communication node, a first signaling of the at least one signaling, that includes the second indication on whether to use the first indication of the duration of validity. The wireless communication device can receive, from the wireless communication node, a second signaling of the at least one signaling, that includes at least one of: (i) the first indication of the duration of validity or (ii) a third indication to perform closed-loop correction. The wireless communication device can determine a value of the duration of validity in response to the second signaling.

In some implementations, the wireless communication device can determine that the third indication is missing in the second signaling. The wireless communication device can determine, in response to the third indication being missing, at least one of: to hold off performing the closed-loop correction; or to perform acquisition of positioning information. In some implementations, the at least one signaling can consist of a single signaling that includes a field value. The wireless communication device can determine, according to the field value, a value of the duration of validity, and/or an indication of whether to use the first indication of the duration of validity.

In some implementations, the single signaling can include a third indication for the wireless communication device to perform closed-loop correction. In some implementations, the wireless communication device can receive the single signaling that includes: the field value, or the field value and the third indication. The wireless communication device can determine the value of the duration of validity in response to the single signaling.

In some implementations, the wireless communication device can determine that at least one of the field value or the third indication is missing in the single signaling. The wireless communication device can determine, in response to the at least one of the field value or the third indication being missing, to perform acquisition of positioning information after expiration of the duration of validity.

At least one aspect is directed to a system, method, apparatus, or a computer-readable medium of the following. A wireless communication node can send/transmit/provide at least one signaling to a wireless communication device. The wireless communication device can determine whether to use an indicated duration of validity of positioning information of the wireless communication device, according to the at least one signaling.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example implementation of a non-terrestrial network (NTN), in accordance with some embodiments of the present disclosure; and

FIG. 4 illustrates a flow diagram of an example method for extending validation duration, in accordance with an embodiment of the present disclosure.

### DETAILED DESCRIPTION

### 1. Mobile Communication Technology and Environment

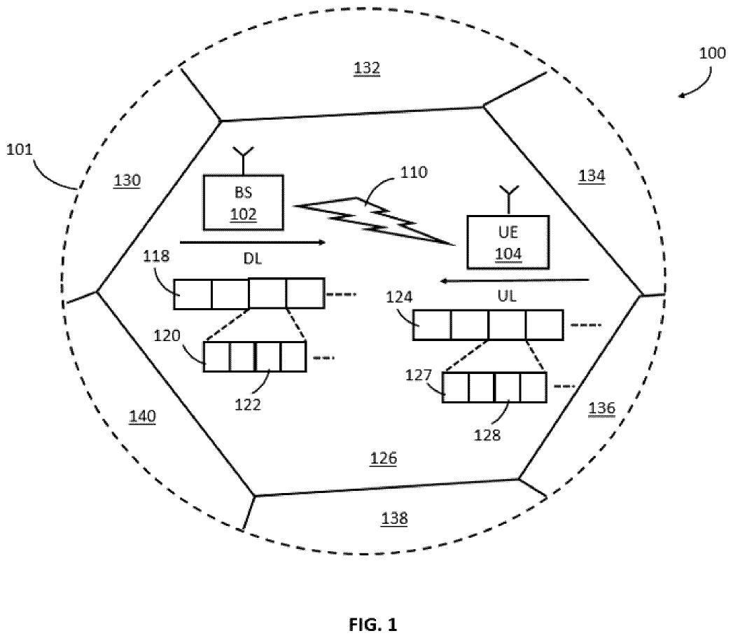

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

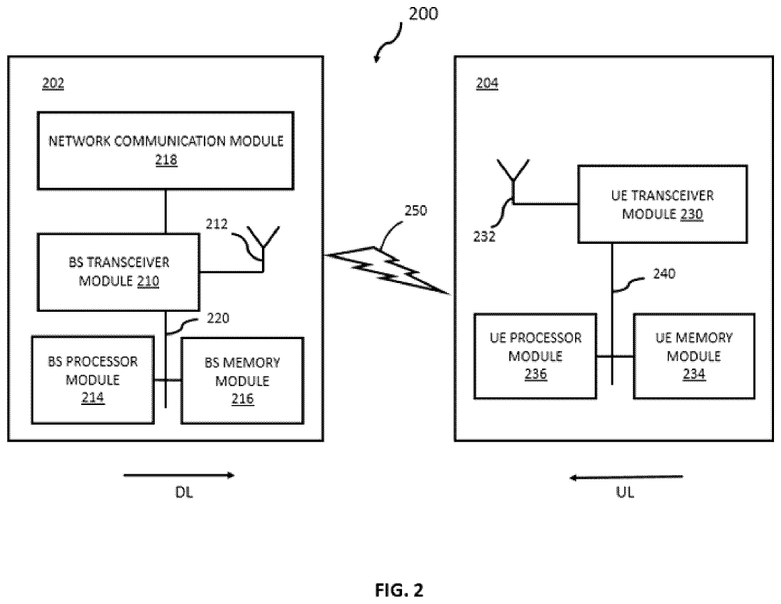

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Extending Validity Duration

In a certain non-terrestrial network (NTN), the UE 104 may acquire/obtain its position/location via a global navigation satellite system (GNSS), such as to pre-compensate the time/frequency error before/prior to an uplink (UL) transmission. The validity of the GNSS position fix (e.g., maintaining, fixing, or defining the location of the UE 104) may be maintained for a duration/period of time. After the validity period expires (e.g., end of the period), the GNSS of a terminal device (e.g., UE 104) can expire. The terminal device can re-acquire GNSS subsequent to or in response to the expiration of the prior GNSS. In certain systems, the UE 104 can autonomously determine its GNSS validity/valid duration (e.g., denoted as “X” in some cases) and/or report information associated with the valid duration to the network (e.g., NTN) via a radio resource control (RRC) signaling once the UE 104 reads/obtains/identifies broadcast information. In this case, the valid duration may be at least one of 10s, 20s, 30s, 40s, 50s, 60s, 5 min, 10 min, 15 min, 20 min, 25 min, 30 min, 60 min, 90 min, 120 min, infinity (e.g., for fixed positioned/stationary terminal device), etc. However, for these certain systems, only the operations of the UE 104 may be considered to maintain or update the UL synchronization with the reacquisition of GNSS based on the reported/provided/indicated valid/validity timer.

To address/resolve the potential time/timing error, the systems and methods of the technical solution discussed herein can specify a closed-loop mechanism by (e.g., directly or indirectly) indicating the value (e.g., timing value or valid duration) to the UE 104 for timing advance (TA) correction. Such mechanisms/operations/processes for addressing the potential time error may also be used or applied to fix, resolve, or address the potential frequency error. In this regard, the systems and methods can alleviate, minimize, mitigate, and/or avoid the potential impact of the potential time error and/or the potential frequency error due to an improper GNSS position, thereby extending the valid/validity duration of the GNSS. To ensure conformity or synchronization between the BS 102 and the UE 104 regarding the value of the GNSS valid duration (e.g., for expected signaling between the BS 102 and the UE 104), the systems and methods can provide or acquire additional signalings and/or mechanisms to the BS 102 and/or the UE 104. In various arrangements, the systems and methods can extend or provide an extended duration of the validity of positioning the UE 104, thereby reducing network traffic, resource consumption, and/or processing by reducing the request for GNSS (e.g., reacquisition of GNSS) from the UE 104, the BS 102, and/or the non-terrestrial device.

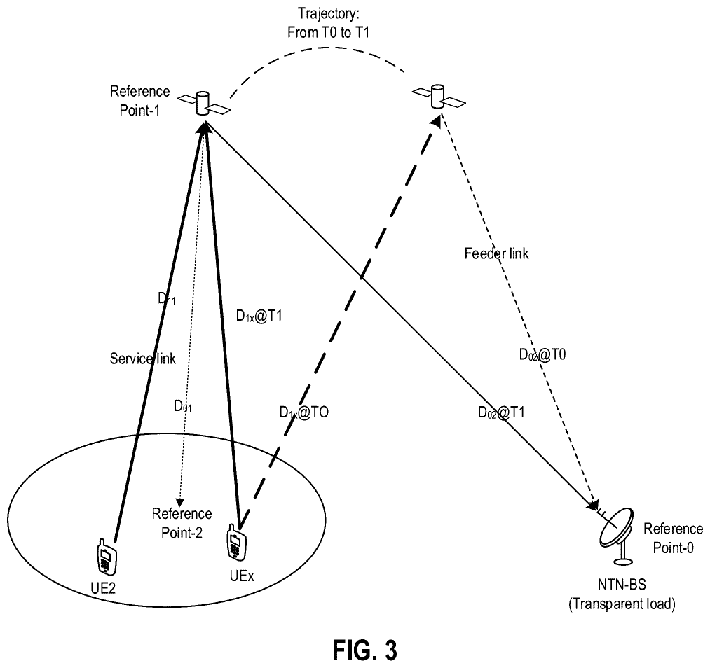

FIG. 3 illustrates an example structure of a transparent NTN, in accordance with some embodiments of the present disclosure. A link between a UE (e.g., a user equipment, the UE 104, the UE 204, a mobile device, a wireless communication device, a terminal, etc.) and a satellite can be a service link. A link between a BS (e.g., a base station, the BS 102, the BS 202, a gNB, an eNB, a wireless communication node, etc.) and a satellite can be a feeder link and can be common for all UEs within the same cell. Due to the high altitude of the satellite, a propagation delay can be relatively large/long. For an NTN, especially with the aerial vehicular entity in geosynchronous equatorial orbit (GEO), the RTT between the UE and the BS can be as long as several hundreds of milliseconds due to long (signal transmission/propagation) distance(s), for example. In low earth orbit (LEO), the RTT between the UE and the BS can be a few milliseconds to tens of milliseconds.

The RTT (Round Trip Time) from the terminal equipment (e.g., UE) to the access network equipment (e.g., BS) can include multiple parts. For instance, one of the parts can include an RTT from the UE 104 to the satellite link (e.g., service link). This RTT can be the UE-specific TA (e.g., time synchronization specific to the terminal equipment) part. Another one of the parts can include an RTT from the satellite to the access network equipment link (e.g., feeder link). This RTT can be a common TA (e.g., time synchronization) part of the RTT between the UE to the BS. The common TA can be partly compensated by the access network equipment (e.g., BS) and/or partly compensated by the terminal equipment/device (e.g., UE). The part compensated by the terminal device may be sent/provided/transmitted to the terminal device through/via a system message.

In various implementations, in addition to broadcasting the common TA that can be compensated by the terminal equipment, the network equipment may broadcast positioning information (e.g., ephemeris information, etc.) of the satellite to assist/help the terminal equipment obtain the location of the satellite for computation/estimation/calculation of the RTT from the terminal equipment to the satellite. Due to the mobility or changes in the positioning of the satellite(s), the common TA and/or positioning information can change. Hence, the positioning information and/or common TA broadcast in the system message can have or be associated with a validity period/duration. The validity duration may be referred to as UL synchronization validity duration. The positioning information and/or common TA may share the same UL synchronization validity duration. The value of the UL synchronization validity duration may be broadcast/transmitted/propagated by the network device to the terminal device through the system information block (SIB), among other types of signaling.

In some cases, in the NTN, the radio frequency (RF) repeater and/or a BS may have a relatively large velocity. This may result in a relatively large frequency offset and/or timing offset on the UE side. To reduce/minimize the frequency offset and/or timing offset, the systems and methods can compute/estimate/determine and/or pre-compensate the offset(s) on the UE side. For example, to determine the one or more offsets, a UE 104 may perform a global navigation satellite system (GNSS) positioning for its own position/location. The UE 104 may perform SIB reading for the satellite and/or high altitude platforms (HAPS) positioning/ephemeris and/or common TA. Each GNSS positioning and/or SIB reading can have a corresponding or associated validity time duration during which the corresponding positioning and/or reading (e.g., of the terminal device, such as the UE 104) may be considered relatively accurate for utilization. The terminal device can start the UL synchronization validity timer according to the positioning information in the broadcast message and/or the epoch time corresponding to the common TA.

### Example Arrangements for UE Extending GNSS Validity Duration Based on BS Configuration

As discussed, the systems and methods of the technical solution can provide a mechanism for determining the duration of the GNSS validity according to or based on a configuration of the BS 102 (e.g., aided or assisted by the BS 102). In this case, the BS 102 can aid or assist with determining the (e.g., extended) validity duration of the GNSS. A configuration can be provided/communicated/transmitted to the UE 104 from the BS 102, for instance, in the initial and/or updated GNSS validity duration. The configuration can correspond to or be a part of a signal indicating an extension of at least the current GNSS validity duration. In some cases, the configuration can indicate an adjusted/extended/modified validity duration, different from the current validity duration. The configuration may be signaled from the BS 102 to the UE 104 via at least one signaling (e.g., SIB signaling, RRC signaling, media access control (MAC) signaling, and/or a downlink control information (DCI) signaling, among others), including the indication and/or extension validity duration(s).

In various arrangements, at least one of, but not limited to, the following can be selected/considered for indicating the validity duration(s) (e.g., extending the validity duration(s) or used as the validity duration(s)):
1) The extension validity duration(s) may be indicated or represented by a specific value. The specific value can be an incremental/increased validity duration (e.g., change/adjustment/delta to the current validity duration) or a new validity duration. In this case, the predetermined or adjustable value indicated via the at least one signaling can represent the adjustment to the validity duration or a new validity duration for the UE 104, for example.
2) The extension validity duration(s) may be represented by a respective index value (e.g., identifier, hash value, look-up value, etc.). Different index values can correspond to or be associated with different validity durations. For example, an index value of 1 can correspond to a value of 20 seconds, an index value of 2 can correspond to a value of 40 seconds, an index value of 3 can correspond to a value of 1 minute, and so forth. In various aspects, the value represented by the index can be an incremental validity duration (e.g., used to increase the current validity duration) or a new validity duration (e.g., used as the validity duration).
3) The extension validity duration(s) can be a coefficient value/factor (e.g., 0.1, 0.2, 0.5, 1, 1.1, 1.5, 2, etc.). Different coefficients can correspond to or be associated with different validity durations. For example, the validity duration can equal to or be increased/incremented by Value=Original Validity Duration×Coefficient. If the coefficient is less than 1, the original/current validity duration can be increased by the computed value based on the original validity duration and the coefficient. If the coefficient is greater than 1, the value can be used to override or replace the original validity duration (e.g., used as the validity duration).

### Example Configuration 1: Explicit Indication of Extended Validity Duration

In certain configurations, the extension of the GNSS validity duration (e.g., assisted by the BS 102) can be indicated to the UE 104 explicitly (e.g., explicit indication mode). In the explicit indication mode, the systems and methods of the technical solution can configure the UE expansion capability with relatively less/lower overhead, thereby avoiding frequent transmission of expansion values, at least to a certain extent.

In some example implementations, the signaling(s) from the BS 102 to the UE 104 can include at least one indicator to trigger the UE 104 to extend the current validity duration. The BS 102 can send/transmit/provide an extended/adjusted validity duration (e.g., incremental validity duration and/or a new validity duration) to the UE 104 along with the indicator. For example, the signaling can include a 1-bit field for indicating the extendibility of the duration of validity. A ‘1’ in the 1-bit field may indicate for or trigger the UE 104 to extend the validity duration based on the current GNSS validity duration or use a new validity duration provided with the signaling (e.g., second indication). An indicated duration of validity (e.g., extension time, such as the value of the validity duration, index, or coefficient value) can be provided as an indication with the 1-bit field, such as based on or according to the value of validity duration sent with the indicator (e.g., first indication). A ‘0’ in the 1-bit field may indicate for the UE 104 to maintain (e.g., not to extend) the current validity duration regardless of whether the value of the validity duration is indicated. In some other cases, the ‘0’ may indicate adjusting the validity duration and ‘1’ may indicate maintaining the validity duration.

The BS 102 may send the indicated duration of validity to the UE 104 as the first indication. The BS 102 may send the 1-bit field to the UE 104 as the second indication. The 1-bit field can correspond to or be a part of the second indication to indicate whether to trigger or use the indicated duration of validity (e.g., value of validity duration, index, or coefficient). The BS 102 can send the first indication and/or the second indication to the UE 104 via one or more signalings. In various aspects, the duration of validity may be configurable/adjustable, such as based on at least one selected indication of the validity duration discussed above (e.g., value of duration of validity, index, or coefficient value).

In certain cases, an error may be detected in the signaling, such as at least one indication from the BS 102 may be missing. For example, the UE 104 may determine that at least one indication (e.g., second indication indicating the validity duration) may be missing in the signaling. In this case, the UE 104 can determine to perform an acquisition process to reacquire the GNSS (e.g., positioning information) from the BS 102. The UE 104 may perform the acquisition process subsequent to or in response to an expiration of the current validity duration. In some cases, the UE 104 may perform the acquisition process in response to determining that the at least one indication is missing.

In some example arrangements, the signaling can include an indicator to trigger the UE 104 to extend the current GNSS validity duration. A fixed validity duration, such as an incremental validity duration and/or a new validity duration, may be predetermined/predefined (e.g., predefined value) for the UE 104. The predefined value may be stored locally on the UE 104. For example, the signaling can include a 1-bit field for indicating the extendibility of the duration of validity. A ‘1’ in the 1-bit field can indicate for the UE 104 to use the predefined value (e.g., incremental value), and/or a ‘0’ can indicate for the UE 104 to maintain the current validity duration (e.g., not use the predefined value) or vice versa. In this case, for every signaling received by the UE 104, the UE 104 can determine whether to increment the current validity duration by the predefined value according to the 1-bit field (e.g., the BS 102 may provide a single indication to the UE 104), for example. The predefined value can be configured/predefined via SIB signaling, RRC signaling, MAC signaling, and/or DCI signaling, among other types of signaling. The UE 104 can extend the current validity duration using the predefined value, such as upon receipt of the indicator for extension.

In some cases, the indication from the BS 102 may be missing. For instance, if the indication of whether to trigger or use the (e.g., predefined) duration of validity is missing or not included in the signaling, the UE 104 can perform the acquisition of the positioning information (e.g., GNSS) when the current validity duration expired.

In various example implementations, the BS 102 can transmit an indicator (e.g., part of at least one signaling) to the UE 104 including at least one indicator to trigger the UE 104 to extend the validity duration. The at least one signaling can include a fixed value for the duration of validity (e.g., incremental validity duration or a new validity duration), such as sent with the indicator or predefined along with the indicator (e.g., in a single signaling). In response to the UE 104 receiving an indication from the BS 102 to trigger the UE 104 to perform closed-loop time and/or frequency corrections, the UE 104 may extend/adjust/modify the current validity duration based on the fixed validity duration for extending the current validity duration. For example, the UE 104 can receive signaling (e.g., indicator with ‘1’ in the 1-bit field) from the BS 102 indicating for the UE 104 to extend the current validity duration based on the fixed value for extending the validity duration in response to each the closed-loop time and/or frequency correction. A ‘0’ can indicate for the UE 104 to maintain the current validity duration. In some cases, the indication from BS 102 may be missing. In this case, the UE 104 can transmit an acquisition request to re-acquire positioning information (e.g., GNSS) in response to an expiration of the current validity duration.

The closed-loop mechanism (e.g., closed-loop calibration process) can be performed as follows. The UE 104 may send/transmit a UL signal to the network (e.g., BS 102). Based on the UL signal, the BS 102 can determine the time-frequency calibration for the UE 104 according to the location/position of the UE 104, and/or other information related to the UE positioning. In response to the determination, the BS 102 can send an indication of UL time-frequency calibration to the UE 104. The UE 104 can transmit the UL signal according to the corrected time-frequency information from the BS 102, thereby completing the operation of the closed-loop calibration process. In this regard, after the time-frequency error accumulated in the current validity duration has been corrected via the closed-loop mechanism, the duration similar to the current validity duration can be extended accordingly.

In some example implementations, the BS 102 can transmit at least one signaling to the UE 104. The at least one signaling (e.g., first signaling) can include an indicator to trigger the UE 104 to extend the current validity duration (e.g., the second indication on whether to use the first indication of the duration validity). The at least one signaling (e.g., second signaling) can include a value for extending the validity duration (e.g., incremental validity duration and/or a new validity duration) and/or an indication (e.g., third indication) to trigger the UE 104 to perform the closed-loop time and/or frequency correction. For example, a 1-bit field can be included in the signaling. The indicator ‘1’ can indicate for the UE 104 to extend the current validity duration, when the UE 104 receives the indication from the BS 102 to perform closed-loop time and/or frequency correction(s). In response to the indication (e.g., second indication and/or third indication), the UE 104 can extend the current validity duration based on the received or indicated validity duration (e.g., first indication). The indicator ‘0’ can indicate for the UE 104 to maintain the current validity duration, for instance, regardless of whether the UE 104 received an indication to perform the closed-loop time and/or frequency correction.

In some cases, a transmission error may occur, where at least one indication is not included or missing from the signaling(s). For instance, the indication to perform closed-loop time and/or frequency corrections from the BS 102 may be missing. In this case, the closed-loop time and/or frequency correction may not be executed (e.g., hold off performing the closed-loop correction) whether the extension indication is configured or not. In response to determining that the indication is missing, the UE 104 may perform the acquisition of the positioning information (e.g., GNSS) when the current validity duration expired. In some cases, the UE 104 may perform the positioning information re-acquisition and hold-off performing the closed-loop correction, for example.

### Example Configuration 2: Implicit Indication of Extended Validity Duration

In various arrangements, the indication for extending the validity duration may be implicitly indicated by the BS 102 (e.g., using implicit indication mode). The implicit indication mode can indicate the enabling and/or disabling of the extension capability via a unique/special value (e.g., bits in the bit field, code, identifier, etc.) of the extension value, which can minimize the signaling overhead caused by the extension capability indication. Implicitly indicating whether the extend the validity duration and/or the value for extension time can reduce network resources as fewer data or transmissions of data are required to indicate the extension of validity duration.

In various example implementations, the at least one signaling can include a bit field indicating the value (e.g., field value) of the duration of validity (e.g., incremental validity duration and/or a new validity duration). The value of the validity duration may implicitly indicate whether to extend the current validity duration. For example, the bit field may be configured as a 3-bit field (e.g., field value with 3-bits) for the extendibility of the validity duration, although other numbers of bits can be configured in the bit field. In this case, the field value can indicate whether the UE 104 may extend the validity duration based on the current validity duration. The value for the validity duration (e.g., indicated duration of validity) may be associated with the field value. The field value (e.g., bits in the bit field) may represent an index or hash value associated with one or more indications, such as stored in a metric/table. For instance, a ‘000’ may indicate for the UE 104 to maintain the current validity duration. Any other bit patterns (e.g., ‘001’, ‘010’, ‘011’, . . . , and/or ‘111’) may indicate for the UE 104 to use a respective value for validity duration associated with the bit patterns, such as ‘001’ for 5 seconds, ‘010’ for 20 seconds, ‘011’, for 40 seconds, etc., depending on the configuration of the table/metric, for example. The metric/table may be stored or maintained locally on the UE 104. The UE 104 may receive update(s) from the BS 102, among other network devices.

In some other cases, one of the bits in the bit field may represent whether to extend the validity duration. For instance, the first bit may indicate whether to perform validity duration extension, such that ‘0xx’ indicates to maintain the current validity duration and ‘1xx’ indicates to use the associated validity duration (e.g., incremental validity duration or new validity duration). Other patterns or configurations of the bits can apply herein for indicating whether to adjust the validity duration and/or the value of the validity duration. In some cases, the indication of the value (e.g., at least a portion of the bit field) from the BS 102 may be missing. In such cases, the UE 104 may perform the acquisition process for re-acquiring the positioning information when the current validity duration expired. The acquisition process may include the UE 104 transmitting/sending/signaling a request for the positioning information to the BS 102, for example.

In some example implementations, the at least one signaling can include a bit field indicating a value (e.g., field value) of the validity duration (e.g., incremental validity duration and/or a new validity duration). The BS 102 may send an indication (e.g., third indication) with the field value (e.g., in the same or different signaling) to trigger the UE 104 to perform closed-loop time and/or frequency correction, which can implicitly indicate whether to extend the current validity duration (or use the indicated duration of validity). For example, the field value may include 3-bits, among others. The field value (e.g., bits in the bit field) can indicate whether the UE 104 uses the value for extending the validity duration based on the current validity duration. The value for the validity duration can be based on or determined according to the validity duration associated with the pattern of the bits (e.g., using the bits as a hash value, identifier, look-up code, etc.). Depending on the configuration, in this case, ‘000’ bits can indicate for the UE 104 to maintain the current validity duration and execute/perform/initiate closed-loop correction (e.g., for time-frequency calibration). Other bit patterns may indicate for the UE 104 to use the indicated value for validity duration and execute the closed-loop correction.

In some implementations, the UE 104 may determine that at least one of the indication (e.g., third indication) and/or the field value from the BS 102 may be missing. In response to the determination, the UE 104 can determine to perform the acquisition of the positioning information from the BS 102 when the current validity duration expired.

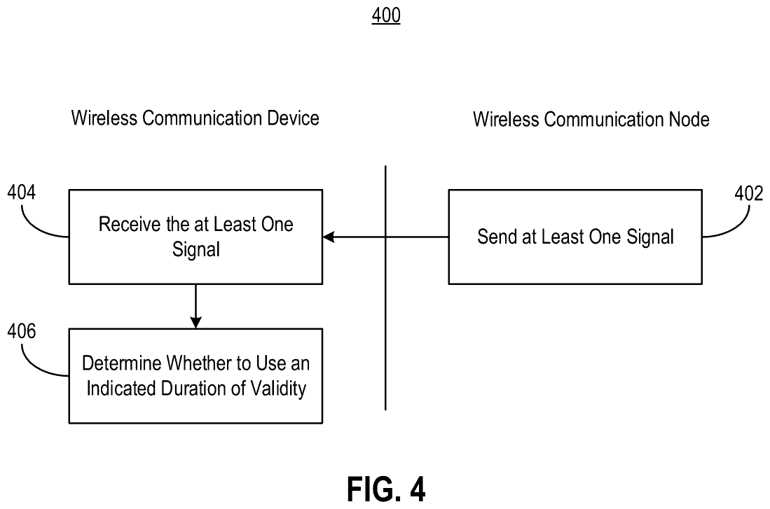

FIG. 4 illustrates a flow diagram of a method 400 for extending the validity duration. The method 400 may be implemented using any one or more of the components and devices detailed herein in conjunction with FIGS. 1-3. In overview, the method 400 may be performed by at least one wireless communication device (e.g., a UE or terminal device), at least one wireless communication node (e.g., a BS, gNB, or access network equipment), at least one satellite, etc., in some embodiments. Additional, fewer, or different operations may be performed in the method 400 depending on the embodiment. At least one aspect of the operations is directed to a system, method, apparatus, or a computer-readable medium.

At operation 402, a wireless communication node can send/transmit/communicate at least one signal to a wireless communication device. At operation 404, the wireless communication device can receive/obtain/acquire the at least one signal from the wireless communication node. The at least one signal can include, for instance, at least one of an indication to trigger the wireless communication device to extend the validity duration (e.g., current GNSS validity duration) and/or an indication of the value of the extension (e.g., indicated duration of validity or extension time, such as incremental validity duration and/or new validity duration), among others.

At operation 406, the wireless communication device can determine whether to use an indicated duration of validity of positioning information of the wireless communication device, according to the at least one signaling. Using the indicated validity duration may include or correspond to extending the current validity duration by the indicated validity duration and/or replacing the current validity duration with the indicated validity duration, for example.

In some implementations, the at least one signaling can include a system information block (SIB) signaling, a radio resource control (RRC) signaling, a media access control (MAC) signaling, and/or a downlink control information (DCI) signaling, among others. In various arrangements, the wireless communication device can determine, from the at least signal, at least one of: a first indication of the duration of validity and/or a second indication to the wireless communication device on/indicating whether to use the first indication of the duration of validity.

In some implementations, the first indication can include at least one of a value of the duration of validity, an index corresponding to the value of the duration of validity, and/or a coefficient value to be used with the duration of validity (e.g., current validity duration) to determine the value of the duration of validity (e.g., incremental validity duration when the coefficient is less than one) or a new duration of validity (e.g., new validity duration when the coefficient is greater than one). Each index can correspond to or be associated with a respective value of the validity duration. In some cases, the first indication can be used as an incremental validity duration to increase/adjust/change/modify/update the existing/current validity duration according to the indicated value. In some cases, the first indication may be used as a new validity duration, such as to replace the current validity duration.

In some implementations, the at least one signaling can consist of a single signaling. In this case, the wireless communication device can receive the single signaling from the wireless communication node. The single signaling can include at least one of (i) the first indication of the duration of validity, and/or (ii) the second indication on whether to use the first indication of the duration of validity. The wireless communication device can determine a value of the duration of validity (e.g., incremental duration of validity or new duration of validity) in response to the second indication.

In some implementations, the wireless communication device may determine that the second indication is missing in the single signaling. In such cases, the wireless communication device can determine, in response to the second indication being missing, to perform acquisition of positioning information, for instance, to re-acquire the positioning information (e.g., GNSS). In some cases, a value of the duration of validity may be a fixed value (e.g., configured for the wireless communication device, such as stored in the local memory). In some other cases, a value of the duration of validity may be defined (e.g., by the wireless communication node). In certain implementations, the value of the duration of validity may be a fixed value and/or a variable value (e.g., defined or configured by the wireless communication node).

In some implementations, the wireless communication device may receive the second indication from the wireless communication node. The wireless communication device may determine a value of the duration of validity in response to the second indication. In some implementations, the wireless communication device may receive a third indication to perform closed-loop correction (e.g., closed-loop time and/or frequency correction) from the wireless communication node. The third indication may be received while within the current duration of validity, for example. The wireless communication device can determine a value of the duration of validity in response to the third indication.

In some arrangements, the wireless communication device may determine that the second indication is missing in the at least one signaling. In response to the second indication being missing, the wireless communication device may determine to perform the acquisition of the positioning information or to perform the closed-loop correction and the acquisition of positioning information.

In some implementations, the wireless communication device may receive a first signaling of the at least one signaling from the wireless communication node. The first signaling can include the second indication on whether to use the first indication of the duration of validity. Further, the wireless communication device can receive a second signaling of the at least one signaling from the wireless communication node. The second signaling can include at least one of: (i) the first indication of the duration of validity or (ii) a third indication to perform closed-loop correction (e.g., closed-loop time and/or frequency correction). The wireless communication device can determine a value of the duration of validity in response to the second signaling.

In some implementations, the wireless communication device can determine that the third indication is missing in the second signaling. In response to the third indication being missing, the wireless communication device can determine at least one of to hold off performing the closed-loop correction and/or to perform the acquisition of positioning information (e.g., re-acquiring the GNSS).

In some implementations, the at least one signaling can consist of a single signaling that includes a field value (e.g., bits in a bit field). The wireless communication device can determine a value of the duration of validity and/or an indication of whether to use the first indication of the duration of validity, according to the field value. For example, ‘000’ field value can indicate not to extend the validity duration, while other field values from ‘001’ to ‘111’ may indicate to extend by an extension time associated with the respective field value.

In some implementations, the single signaling can include a third indication for the wireless communication device to perform closed-loop correction. In some implementations, the wireless communication device can receive the single signaling that includes: the field value, or the field value and the third indication. The wireless communication device may determine the value of the duration of validity in response to the single signaling, for instance, according to the field value associated with a respective value of validity duration.

In some implementations, the wireless communication device can determine that at least one of the field value and/or the third indication is missing in the single signaling. In response to the at least one of the field value or the third indication being missing, the wireless communication device may determine to perform the acquisition of positioning information (e.g., GNSS) after expiration of the duration of validity (e.g., current validity duration/period).

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
receiving, by a wireless communication device from a wireless communication node, at least one signaling; and
determining, by the wireless communication device, whether to use an indicated duration of validity of positioning information of the wireless communication device, according to the at least one signaling.

2. The method of claim 1, wherein the at least one signaling includes a system information block (SIB) signaling, a radio resource control (RRC) signaling, a media access control (MAC) signaling, or a downlink control information (DCI) signaling.

3. The method of claim 1, comprising:
determining, by the wireless communication device from the at least one signaling, at least one of: a first indication of the duration of validity, or a second indication to the wireless communication device on whether to use the first indication of the duration of validity.

4. The method of claim 3, wherein the first indication comprising:
a value of the duration of validity,
an index corresponding to the value of the duration of validity, or
a coefficient value to be used with the duration of validity to determine the value of the duration of validity or a new duration of validity.

5. The method of claim 3, wherein the at least one signaling consists of a single signaling, and the method comprises:
receiving, by the wireless communication device from the wireless communication node, the single signaling, the single signaling including: (i) the first indication of the duration of validity, and (ii) the second indication on whether to use the first indication of the duration of validity; and
determining, by the wireless communication device, a value of the duration of validity in response to the second indication.

6. The method of claim 5, comprising:
determining, by the wireless communication device, that the second indication is missing in the single signaling; and
determining, by the wireless communication device in response to the second indication being missing, to perform acquisition of positioning information.

7. The method of claim 3, wherein a value of the duration of validity is a fixed value.

8. The method of claim 3, wherein a value of the duration of validity is defined.

9. The method of claim 3, comprising:
receiving, by the wireless communication device from the wireless communication node, the second indication; and
determining, by the wireless communication device, a value of the duration of validity in response to the second indication.

10. The method of claim 3, comprising:
receiving, by the wireless communication device from the wireless communication node, a third indication to perform closed-loop correction; and
determining, by the wireless communication device, a value of the duration of validity in response to the third indication.

11. The method of claim 9, comprising:
determining, by the wireless communication device, that the second indication is missing in the at least one signaling; and
determining, by the wireless communication device in response to the second indication being missing, to perform acquisition of positioning information or to perform the closed-loop correction and the acquisition of positioning information.

12. The method of claim 3, comprising:
receiving, by the wireless communication device from the wireless communication node, a first signaling of the at least one signaling, that includes the second indication on whether to use the first indication of the duration of validity;
receiving, by the wireless communication device from the wireless communication node, a second signaling of the at least one signaling, that includes at least one of: (i) the first indication of the duration of validity or (ii) a third indication to perform closed-loop correction; and
determining, by the wireless communication device, a value of the duration of validity in response to the second signaling.

13. The method of claim 12, comprising:
determining, by the wireless communication device, that the third indication is missing in the second signaling; and
determining, by the wireless communication device in response to the third indication being missing, at least one of:
to hold off performing the closed-loop correction; or
to perform acquisition of positioning information.

14. The method of claim 3, wherein the at least one signaling consists of a single signaling that includes a field value, and the method comprises:
determining, by the wireless communication device according to the field value, a value of the duration of validity, and an indication of whether to use the first indication of the duration of validity.

15. The method of claim 14, wherein the single signaling includes a third indication for the wireless communication device to perform closed-loop correction.

16. The method of claim 14, comprising:
receiving, by the wireless communication device, the single signaling that includes: the field value, or the field value and the third indication; and
determining, by the wireless communication device, the value of the duration of validity in response to the single signaling.

17. The method of claim 14, comprising:
determining, by the wireless communication device, that at least one of the field value or the third indication is missing in the single signaling; and
determining, by the wireless communication device in response to the at least one of the field value or the third indication being missing, to perform acquisition of positioning information after expiration of the duration of validity.

18. A method comprising:
sending, by a wireless communication node to a wireless communication device, at least one signaling,
wherein the wireless communication device determines whether to use an indicated duration of validity of positioning information of the wireless communication device, according to the at least one signaling.

19. A wireless communication node, comprising:
at least one processor configured to:
send, via a transmitter to a wireless communication device, at least one signaling,
wherein the wireless communication device determines whether to use an indicated duration of validity of positioning information of the wireless communication device, according to the at least one signaling.

20. A wireless communication device, comprising:
at least one processor configured to:
receive, via a receiver from a wireless communication node, at least one signaling; and
determine whether to use an indicated duration of validity of positioning information of the wireless communication device, according to the at least one signaling.
